(19) United States
(12) Patent Application Publication
(10) Pub. No.: US 2009/0260401 A1
(43) Pub. Date: Oct. 22, 2009

(54) HEATER HAVING MULTI HOT-ZONES, FURNACE HAVING THE HEATER FOR DRAWING DOWN OPTICAL FIBER PREFORM INTO OPTICAL FIBER, AND METHOD FOR DRAWING OPTICAL FIBER USING THE SAME

(76) Inventors: Hyung-Soo Shin, Seoul (KR); Young-Gyu Yang, Gyeonggi-do (KR); Lae-Hyuk Park, Seoul (KR)

Correspondence Address: STROOCK & STROOCK & LAVAN LLP, 180 MAIDEN LANE, NEW YORK, NY, 10038, US

(21) Appl. No.: 12/279,636

(22) PCT Filed: Nov. 13, 2006
(86) PCT No.: PCT/KR2006/004727

§ 371 Date: Sep. 18, 2008

(30) Foreign Application Priority Data
Feb. 15, 2006 (KR) 10-2006-0014592

(51) Int. Cl. C03B 37/02; C03B 5/235; C03B 37/029

(52) U.S. Cl. 65/435; 65/507; 65/509

(57) ABSTRACT

Disclosed is a heating element having a ring shape provided in a furnace for drawing an optical fiber from a large-diameter preform so as to heat and melt a preform. The heating element according to heating element includes at least two hot zones having different heating temperatures, wherein one of the hot zones is arranged in a neck-down region of the preform to heat the preform at a temperature suitable for drawing an optical fiber. Also, the hot zone includes a first heating unit for heating a preform at a temperature suitable for draw an optical fiber from the preform; and a second heating unit for heating a surface of the preform to a relatively lower temperature than the first heating unit.

### TECHNICAL FIELD

The present invention relates to a technique for drawing an optical fiber using an optical fiber preform, and more particularly to a furnace for drawing an optical fiber by melting an optical fiber preform.

### BACKGROUND ART

Generally, an optical fiber is obtained by drawing a transparent glass ferrite, so called an optical fiber preform, in a high-temperature furnace. As widely known in the art, the furnaces are divided into a resistance furnace and an induction furnace.

FIG. 1 shows a configuration of a typical furnace for drawing an optical fiber. The furnace for drawing an optical fiber as shown in FIG. 1 is described in detail, for example, in Japan Patent Publication No.: H3-24421 or U.S. Pat. No. 5,637,130.

As shown in FIG. 1, a ring-shaped heater 13 for heating and melting an optical fiber preform 12 is provided in a furnace body 11 made of stainless steel. A core tube 17 for carrying an optical fiber preform 12 is arranged in the inside of the heater 13, wherein the optical fiber preform 12 is installed vertically and supplied through an top opening of the core tube 17. Generally, the core tube 17 is made of carbon material and fixed in the furnace body 11. Also, the core tube 17 is divided into an upper cylinder and a lower cylinder with the center of the heater 13. The upper cylinder should have at least a higher diameter than the preform.

Also, a space between the furnace body 11 and the heater 13 is filled with a heat-insulating material 16 to prevent external diffusion of the heat emitted from the heater 13. The top opening is covered with a cap member 18.

A gas inlet 17a for allowing an inert gas 20 such as nitrogen or helium to flow in the core tube 17 is installed in the upper cylinder of the core tube 17. The inert gas 20 flowing in the core tube through the gas inlet 17a moves along with the preform 12, and then flows out through the bottom opening of the core tube 17. As a result, the inside of the furnace may be maintained under an atmosphere of the inert gas 20, and oxidation of the heater 13 or the core tube 17 by the influx of external air may be minimized.

The optical fiber preform 12 carried in the core tube 17 through the top opening is heated and melted by the heater 13, and an optical fiber 15 having a micro diameter is drawn in a neck-down region in which a hot zone (a heating zone) is formed by the heater 13.

There has been an attempt to obtain an optical fiber preform having an increasing diameter so as to improve its productivity with the development of drawing techniques. That is, a large-diameter preform has been generally used for drawing the maximum length of an optical fiber from one preform. However, the increase in a size of the preform makes it difficult to increase a drawing speed since a diameter of the optical fiber increases in proportion to the size of the preform.

However, even if the size of the optical fiber preform is increased as described above, it is difficult to increase the drawing speed of the optical fiber to about 1,000˜2,000 mpm or more.

The relationship of the following Equation 1 is satisfied between a feeding speed of the optical fiber preform and a drawing speed of the optical fiber.

$$Vf = {( \frac{d}{D} )}^{2} \times {U}_{o} \qquad Equation 1$$

(wherein, Vf: a feeding speed of a preform, D: an external diameter of a preform, d: an external diameter of an optical fiber, and Uo: a drawing speed of an optical fiber).

That is, the feeding speed of the optical fiber preform is in inverse proportion to the square of an external diameter of the preform, and therefore a retention time of the preform in the furnace is in proportion to the square of the external diameter of the preform. As a result, retention time of the preform in the furnace is increased if the external diameter of the optical fiber preform is increased, which results in various problems as described in the following.

In the drawing process of an optical fiber, the heater should have a temperature greater than 1,700° C. which is a melting temperature of SiO₂, and generally a temperature between about 1,800° C. and 2,300° C. A certain amount of SiO₂ is evaporated if SiO₂ is melted under the above-mentioned temperature condition. The evaporated SiO₂ is attached to an upper part of a neck-down region of the preform.

Referring to FIG. 2, SiO₂ constituting the preform 12 is melted in a hot zone of the heater 13 to form a neck-down region (A), and an optical fiber 15 is then drawn from the neck-down region (A). At this time, a trace of SiO₂ is evaporated from the neck-down region and flows up to an upper part (B) of the preform. The evaporated SiO₂ is attached to an upper part of the neck-down region having a relatively lower temperature due to thermophoresis, resulting in formation of a contamination zone 21.

A trace of SiO₂ evaporated as shown in FIG. 2 is re-attached to the preform due to a short retention time if the preform has a small external diameter, but an amount of SiO₂ re-attached to the preform increases if the preform has an increased external diameter.

The contamination zone 21 to which the evaporated SiO₂ is attached enters the neck-down region (A) as the preform moves down, and rumples 22 as shown in FIG. 2 are formed in the neck-down region of the preform due to the presence of attached matters which are ununiformly attached to a surface of the preform. If the rumples are formed in the surface of the preform, the optical fiber may have a low ovality, or be cut off during the drawing process.

### DISCLOSURE OF INVENTION

### Technical Problem

Accordingly, the present invention is designed to solve the problems of the prior art, and therefore it is an object of the present invention to provide a novel heater capable of solving a contamination-related problem caused by attachment of evaporated SiO₂ in drawing an optical fiber from a large-diameter optical fiber preform.

### Technical Solution

The first aspect of the present invention is achieved by providing a heating element having a ring shape provided in a furnace for drawing an optical fiber from a large-diameter preform so as to heat and melt a preform, wherein the heating element comprises at least two hot zones having different heating temperatures, and wherein one of the hot zones is arranged in a neck-down region of the preform so as to heat the preform at a temperature suitable for drawing an optical fiber.

It is characterized in that the hot zone includes a first heating unit for heating a preform at a temperature suitable for drawing an optical fiber from the preform; and a second heating unit for heating a surface of the preform to a relatively lower temperature than the first heating unit, wherein the first heating unit is arranged in a neck-down region of the preform, and the second heating unit is arranged above the neck-down region.

Also, the heating element is preferably an electric resistance heater made of graphite or carbon material, and the first heating unit should have a relatively smaller thickness than the second heating unit.

The second aspect of the present invention is achieved by providing a furnace for drawing an optical fiber, the furnace including a furnace body having an top opening through which an optical fiber preform is introduced and a bottom opening through which an optical fiber drawn from the preform is discharged; a gas supply means for flowing an inert gas into a furnace body to maintain an inert gas atmosphere in the inside of the furnace body; and a heating means installed inside the furnace body and heating the optical fiber preform to draw an optical fiber, wherein the heating means includes a first heating unit for heating a preform at a temperature suitable for drawing an optical fiber from the preform; and a second heating unit for heating a surface of the preform to a relatively lower temperature than the first heating unit, wherein the first heating unit is arranged in a neck-down region of the preform, and the second heating unit is arranged above the neck-down region.

The third aspect of the present invention is achieved by providing a method for drawing an optical fiber by melting a preform in a furnace, the method including: (a) supplying a preform into the inside of the furnace; (b) arranging the preform and the heater so that a neck-down region of the preform corresponds to the first heating unit and an upper part of the neck-down region of the preform corresponds to the second heating unit; (c) applying power to the heater such that the first heating unit and the second heating unit can generate heat at different temperatures; (d) drawing an optical fiber by heating a surface of the preform in the neck-down region to a first temperature; and (e) heating a surface of the preform arranged above the neck-down region to a second temperature lower than the first temperature, wherein the furnace includes an electric resistance heater made of graphite or carbon material, the electric resistance heater including a first heating unit for heating a preform at a temperature suitable for drawing an optical fiber from the preform; and a second heating unit for heating a surface of the preform to a relatively lower temperature than the first heating unit.

### BRIEF DESCRIPTION OF THE DRAWINGS

Preferred embodiments of the present invention will be more fully described in the following detailed description with reference to the accompanying drawings, but the accompanying drawings will be illustrative of preferred embodiments of the present invention, so it should be understood that the description proposed herein is not intended to be limited referring to the accompanying drawings. In the drawings:

FIG. 1 is a cross-sectional view showing a conventional furnace for drawing an optical fiber.

FIG. 2 is a state diagram illustrating that a contamination zone is formed in an upper part of a neck-down region due to evaporated SiO₂.

FIG. 3 is a cross-sectional view showing a furnace for drawing an optical fiber according to one preferred embodiment of the present invention.

FIG. 4 is a graph illustrating temperature distribution of a heater according to one preferred embodiment of the present invention.

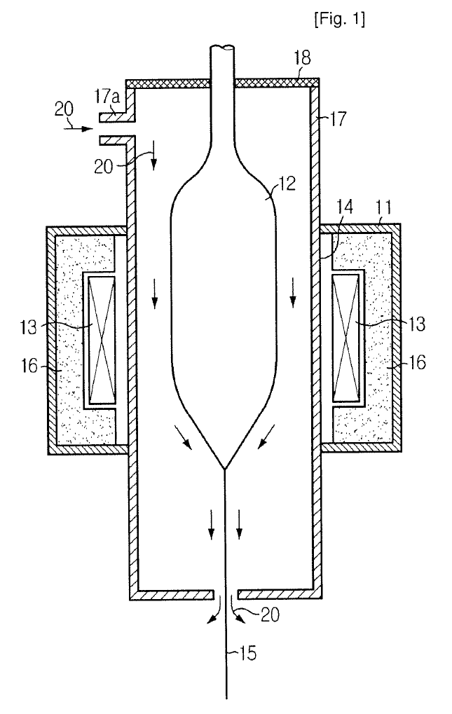

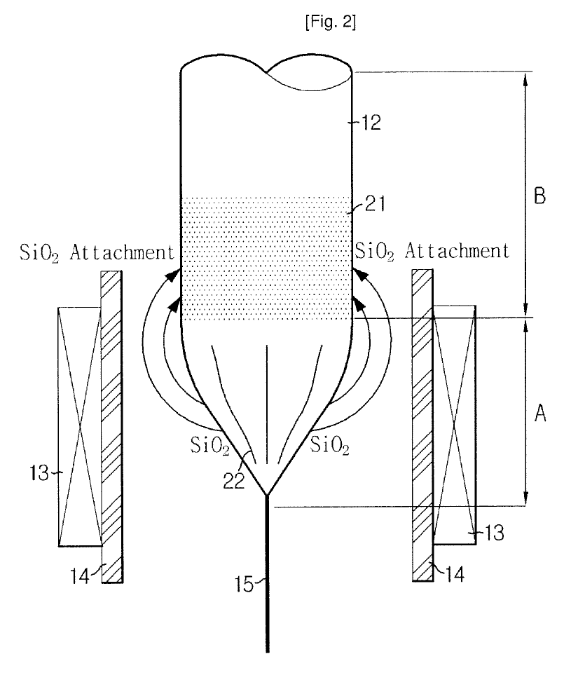

### BEST MODE FOR CARRYING OUT THE INVENTION

Hereinafter, preferred embodiments of the present invention will be described in detail referring to the accompanying drawings. Prior to the description, it should be understood that the terms used in the specification and appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

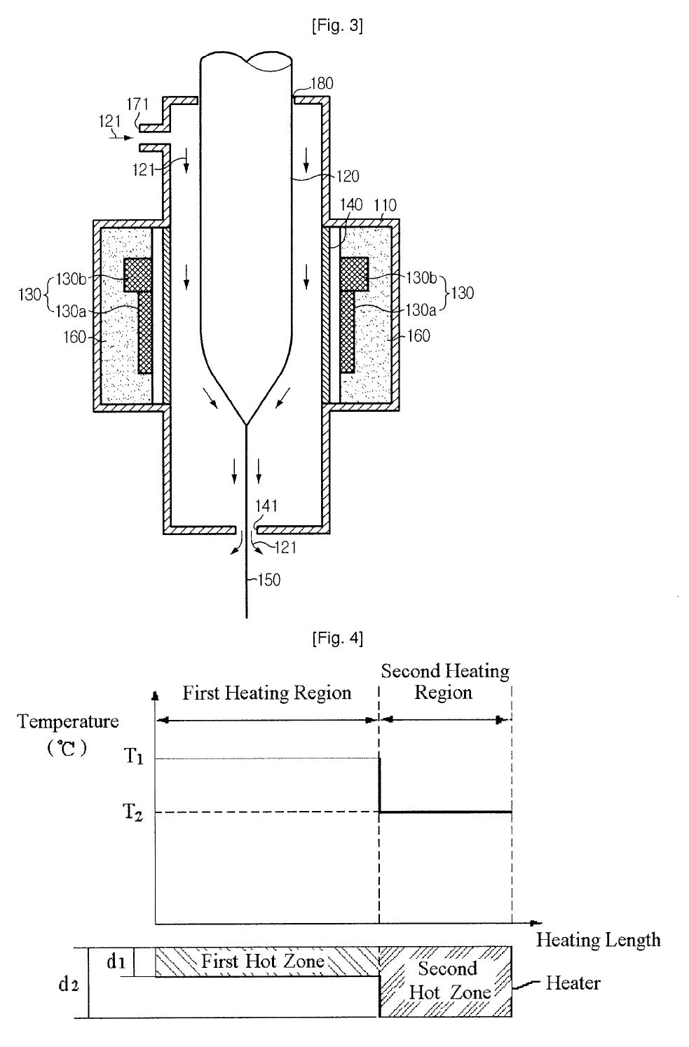

A schematic configuration of a furnace for drawing an optical fiber is shown in FIG. 3, the furnace including a heater with a modified configuration according to one preferred embodiment of the present invention.

Referring to FIG. 3, the furnace for drawing an optical fiber according to the present invention preferably includes a cylindric furnace body 110 made generally of stainless steel. An top opening 180 through which the optical fiber preform 120 is injected is formed in the top of the furnace body 110, and a bottom opening 141, through which an optical fiber 150 drawn from the preform 120 passes and is discharged, is formed in the bottom of the furnace body 110. Also, a gas inlet 171 for allowing an inert gas 121 such as nitrogen or helium to flow in the furnace is formed in one side of the upper part of the furnace body 100. The inert gas flowing through the gas inlet 171 moves down along with the preform 120, and then flows out through the bottom opening 141. As a result, the inside of the furnace is maintained under an inert gas atmosphere.

The inside of the furnace body 110 is provided with a heating means 130 for carrying the introduced preform 120 in a melting space and drawing an optical fiber by heating and melting the preform 120; a heat-insulating unit 160 for preventing heat, emitted from the heating means, from being diffused to the outside; and a muffle tube 140 for indirectly transferring heat from the heating means to the preform while carrying the optical fiber preform. The heating means 130 is a heater made of graphite or carbon material, which receives electricity from a power source (not shown) to generate heat by means of resistance, and it melts the optical fiber preform 120 by maintaining an internal temperature of the furnace to about 1,800 to 2,300° C. As another example, the heating means 130 may also heat the preform in an induction heating process using a coil (not shown) installed in a space between the muffle tube 140 and the furnace body 110.

According to the present invention, the heating means 130 includes at least two different hot zones. That is, referring to FIG. 4, the heating means 130 of the present invention includes a melting zone 130a (a first hot zone) for heating a preform arranged in a neck-down region at a temperature (T₁: 1,800 to 2,300° C.) suitable for drawing an optical fiber 150 from the preform 120; and a preheating zone 130b (a second hot zone) for heating a preform to a temperature (T₂) of 1,500 to 1,800° C. so as to remove foreign matters, attached to a surface of the preform, using a fire polishing effect or to sinter the attached SiO₂ particles.

The melting zone 130a corresponds to a neck-down region (a first heating region) in which an optical fiber is drawn from a preform, and the preheating zone 130b corresponds to the upper part of the neck-down region, namely a zone (a second heating region) to which SiO₂ particles evaporated in the neck-down region are attached due to thermophoresis.

In order to form different hot zones in the heating means 130, various methods may be used. That is, two heating means which can independently control temperature are connected to each other, or other heating means having different turn numbers of coil may be used to heat zones with different temperature.

If the heating means 130 is a resistance heater made of graphite or carbon material, the heater is designed with different thickness, as shown in FIG. 4. Every zone may be realized with different temperatures by setting a thickness (d₂) of the second hot zone 130b to a higher level than a thickness (d₁) of the first hot zone 130a. That is, an heating temperature (T₂) of the second hot zone having a relatively thicker thickness is lower than an heating temperature (T₁) of the first hot zone.

A conventional heater having a single hot zone and a heater of the present invention having different hot zones were used to draw optical fibers from a preform, and then the drawn optical fibers were measured for ovality and breaking ratio. The results are listed in the following Table 1.

TABLE 1

| | Conventional Heater | Inventive Heater |
|---|---|---|
| Ovality | 0.6% | 0.2% or less |
| Breaking Ratio of Fiber in | 2.5% | 0.5% or less |
| Drawing Length of 1,000 km | | |

As listed in the Table 1, it is revealed that the heater according to the present invention may significantly improve the ovality and breaking ratio of the optical fiber by dividing a zone of the heater into a melting zone and a preheating zone and preheating a zone to which the evaporated SiO₂ particles are attached to a pre-determined temperature (T₂).

The process for drawing an optical fiber from a preform using the furnace of the present invention including the heater having the above-mentioned configuration will be described in detail, as follows.

A preform 120 is supplied to the inside of a furnace through an top opening 180 of a furnace body 110 using a known supply unit (not shown). Then, a power source (not shown) is used to supply an electric current to a heating means 130. As a result, a first hot zone 130a of the heating means 130 generates heat with a temperature T₁ (1,800˜2,300° C.), and a second hot zone 130b generates heat with a temperature T₂ (1,500˜1,800° C.).

Therefore, a preform zone corresponding to the neck-down region (a first heating region) is heated and melted, and then an optical fiber 150 is drawn from the bottom of the heater. Meanwhile, SiO₂ particles evaporated in a surface of the preform in the neck-down region moves up to the top (a second heating region) of the neck-down region, and then are heated to the temperature T₂ (1,500˜1,800° C.), and therefore the SiO₂ particles removed off or sintered in the surface of the preform. Accordingly, the evaporated SiO₂ particles may be prevented from being re-attached to the upper part of the neck-down region due to thermophoresis, or foreign matters may be prevented from being formed ununiformly.

### INDUSTRIAL APPLICABILITY

The optical fiber according to the present invention may be useful to significantly reduce the ovality and breaking ratio since a surface of the optical fiber preform may be maintained clean without attachment of foreign matters to the surface of the optical fiber preform.

1. A heating element having a ring shape, provided in a furnace for drawing an optical fiber from a large-diameter preform so as to heat and melt a preform, wherein the heating element comprises at least two hot zones having different heating temperatures, and
wherein one of the hot zones is arranged in a neck-down region of the preform so as to heat the preform at a temperature suitable for drawing an optical fiber.

2. The heating element according to claim 1, wherein the hot zone includes:
a first heating unit for heating the preform at a temperature suitable for drawing an optical fiber from the preform; and
a second heating unit for heating a surface of the preform to a relatively lower temperature than the first heating unit,
wherein the first heating unit is arranged in a neck-down region of the preform, and the second heating unit is arranged above the neck-down region.

3. The heating element according to claim 2, wherein the heating element is an electric resistance heater made of graphite or carbon material.

4. The heating element according to claim 3, wherein the first heating unit has a relatively smaller thickness than the second heating unit.

5. The heating element according to claim 3, wherein the first heating unit has an heating temperature of 1,800 to 2,300° C., and the second heating unit has an heating temperature of 1,500 to 1,800° C.

6. A furnace for drawing an optical fiber, the furnace comprising:
a furnace body having an top opening through which an optical fiber preform is introduced and a bottom opening through which an optical fiber drawn from the preform is discharged;
a gas supply means for flowing an inert gas into a furnace body to maintain the inside of the furnace body under an inert gas atmosphere; and
a heating means installed inside the furnace body and heating the optical fiber preform to draw an optical fiber,
wherein the heating means includes:
a first heating unit for heating a preform at a temperature suitable for drawing an optical fiber from the preform; and
a second heating unit for heating a surface of the preform to a relatively lower temperature than the first heating unit,
wherein the first heating unit is arranged in a neck-down region of the preform, and the second heating unit is arranged above the neck-down region.

7. The furnace for drawing an optical fiber according to claim 6, wherein the heating means is an electric resistance heater made of graphite or carbon material.

8. The furnace for drawing an optical fiber according to claim 7, wherein the first heating unit has a relatively smaller thickness than the second heating unit.

9. The furnace for drawing an optical fiber according to claim 8, wherein the first heating unit has an heating temperature of 1,800 to 2,300° C., and the second heating unit has an heating temperature of 1,500 to 1,800° C.

10. A method for drawing an optical fiber by melting a preform in a furnace that includes an electric resistance heater made of graphite or carbon material, the electric resistance heater including:
a first heating unit for heating a preform at a temperature suitable for drawing an optical fiber from the preform; and
a second heating unit for heating a surface of the preform to a relatively lower temperature than the first heating unit,
wherein the method comprises:
(a) supplying a preform into the inside of the furnace;
(b) arranging the preform and the heater so that a neck-down region of the preform corresponds to the first heating unit and an upper part of the neck-down region of the preform corresponds to the second heating unit;
(c) applying power to the heater such that the first heating unit and the second heating unit generate heat at different temperatures;
(d) drawing an optical fiber by heating a surface of the preform arranged in the neck-down region to a first temperature; and
(e) heating a surface of the preform arranged above the neck-down region to a second temperature lower than the first temperature.

11. The method for drawing an optical fiber according to claim 10, wherein the first temperature ranges from 1,800° C. to 2,300° C., and the second temperature ranges from 1,500° C. to 1,800° C.
